(19) United States
(12) Patent Application Publication
(10) Pub. No.: US 2025/0104117 A1
(43) Pub. Date: Mar. 27, 2025

(54) SYSTEM AND METHOD FOR DYNAMIC CREATIVE OPTIMIZATION VIA GENERATIVE AI

(71) Applicant: YAHOO ASSETS LLC, New York, NY (US)

(72) Inventors: Ariel Raviv, Haifa (IL); Oren Shlomo Somekh, Kfar-Netter (IL)

(21) Appl. No.: 18/475,869

(22) Filed: Sep. 27, 2023

(51) Int. Cl. G06Q 30/0241; G06Q 30/0242; G06Q 30/0251

(52) U.S. Cl. CPC G06Q 30/0276; G06Q 30/0244; G06Q 30/0255

(57) ABSTRACT

The present teaching relates to displaying ads. A generative artificial intelligence (AI) model for creating advertisement assets is obtained, via machine learning, based on training data generated based on online feedback information on previously displayed advertisements. Base advertisement information associated with an advertisement of a product specifying some attributes characterizing the product is received. Using the generative AI model, multiple advertisement assets are created with respect to some attribute of the advertisement. Each advertisement asset is a representation of an attribute. These advertisement assets are used to form different asset combinations, each of which can be used to display the advertisement.

### BACKGROUND

### 1. Technical Field

The present teaching generally relates to electronic content. More specifically, the present teaching relates to generating electronic content.

### 2. Technical Background

With the development of the Internet and the ubiquitous network connections, more and more commercial and social activities are conducted online. Networked content is served to millions, some requested and some recommended. For example, a user can request certain content using queries via, e.g., keywords, to facilitate searches. The online platforms that make electronic content available to users may leverage the opportunities to interact with users to recommend content, which may include both general content and/or advertisements (ads). An ad recommended for display to a particular user may be selected or recommended via ad recommendation by, e.g., maximizing estimated performance of the ad. Some estimated performance may be determined with respect to each specific setting, including the platform, the geo-region where the ad is to be displayed, the preference of the user, and the past performance of the ad in a similar setting.

A typical ad display framework 100 as shown in FIG. 1A may include a backend ad recommendation server 140 and a front-end serving engine 130. The ad serving engine 130 may be associated with a particular online platform and the backend ad recommendation server 140 may be provided for selecting an ad, e.g., from a plurality of ads archived in storage 160, for recommendation in response to an ad display opportunity presented by an ad serving engine 130 at the frontend. In operation, a user 110 interacts with the frontend ad serving engine 130 via a computing device 120. When an ad display opportunity is available on an online web page presented to the user 110 on device 120, the ad serving engine 130 sends a request to the ad recommendation server 140 in the backend for a recommended ad for the ad display opportunity. The request may be sent with contextual information such as a user operating on the device 120 of a particular platform and the contextual information may be relevant to the ad being selected or recommended, such as user information, browser information, geo-location information, etc.

Upon receiving a request with user/contextual information, the ad recommendation server 140 may operate to select one or more ads from an ad storage 160, based on, e.g., user information and the contextual information associated with the ad display opportunity in accordance with some previously trained ad selection models 150. The ad storage may store not only ads 160-1, but also assets for the ads 160-3, as well as certain combinations of ad assets for the stored ads 160-2. Each ad may be composed of multiple attributes which may include, e.g., a title 170, an image 180, and a description 190, as illustrated in FIG. 1B. Instead of having a fixed set of attributes for each ad, in recent years, to further enhance the performance of ads, different assets for each attribute may be provided so that an ad may be displayed in multiple ways. For instance, attribute title 170 may have multiple assets (e.g., 3 ways to entitle a product, 170-1, 170-2, and 170-3), attribute image 180 may also have three different assets (e.g., show a product from 3 perspective 180-1, 180-2, and 180-3), and attribute description may also have different assets (e.g., 3 ways to describe the same product 190-1, 190-2, and 190-2).

Based on the assets for different ad attributes, a plurality of combinations (e.g., 27 combinations based on 3 assets per attribute or 3×3×3) may be created, corresponding to a plurality of ways of displaying the ad. Such combinations may be archived in 160-2 and a specific combination for a recommended ad may also be recommended based on, e.g., asset combination prediction models 155. FIG. 1C shows an example of a specific combination with the title, image, and description realized using one of the multiple stored combinations. In this framework, the assets for ad attributes are provided in a predetermined manner so that the combinations are formed based on a fixed set of given assets.

There is a need for a solution that can enhance the performance of the traditional approaches in maximizing the revenue via advertising.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for displaying ads. A generative artificial intelligence (AI) model for creating advertisement assets is obtained, via machine learning, based on training data generated based on online feedback information on previously displayed advertisements. Base advertisement information associated with an advertisement of a product specifying some attributes characterizing the product is received. Using the generative AI model, multiple advertisement assets are created with respect to some attribute of the advertisement. Each advertisement asset is a representation of an attribute. These advertisement assets are used to form different asset combinations, each of which can be used to display the advertisement.

In a different example, a system is disclosed for displaying ads that includes a machine learning engine and an AI-assistant ad asset generator. The machine learning engine is configured for obtaining, via machine learning, generative artificial intelligence (AI) models for creating advertisement assets based on training data generated based on online feedback information on previously displayed advertisements. The AI-assisted ad asset generator is configured for receiving base advertisement information associated with an advertisement for a product specifying some attributes to characterize the product and creating advertisement assets related to some attributes of the advertisement based on the generative AI models. Each advertisement asset corresponds to a representation of one of the at least one attribute. The created advertisement assets are used to form different asset combinations each of which can be used to display the advertisement.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for displaying ads. The information, when read by the machine, causes the machine to perform various steps. A generative artificial intelligence (AI) model for creating advertisement assets is obtained, via machine learning, based on training data generated based on online feedback information on previously displayed advertisements. Base advertisement information associated with an advertisement of a product specifying some attributes characterizing the product is received. Using the generative AI model, multiple advertisement assets are created with respect to some attribute of the advertisement. Each advertisement asset is a representation of an attribute. These advertisement assets are used to form different asset combinations, each of which can be used to display the advertisement.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A provides an example advertisement recommendation system with a recommendation of ad as a combination of assets;

FIG. 1B shows an example of multiple combinations of attribute assets for an ad that can be used to render the ad;

FIG. 1C illustrates an example ad rendered based on a specific combination of assets for different attributes of the ad, in accordance with an exemplary embodiment of the present teaching;

FIG. 2A depicts an exemplary high level system diagram of an ad recommendation framework based on ad assets automatically generated via generative AI, in accordance with an embodiment of the present teaching;

FIG. 2B is a flowchart of an exemplary process for AI-assisted ad asset generation based on a generative AI model, in accordance with an embodiment of the present teaching;

FIG. 2C is a flowchart of an exemplary process for ad recommendation of an ad based on an attribute asset combination determined in accordance with estimated performance metrics, in accordance with an embodiment of the present teaching;

FIG. 3A shows exemplary sources of base ad information;

FIG. 3B shows exemplary types of information included in the base ad information;

FIG. 3C illustrates exemplary types of variations that may be applied to base ad information in generating ad assets, in accordance with an exemplary embodiment of the present teaching;

FIG. 3D illustrates exemplary automatic image modifications automatically made via generative AI to base ad information of a product, in accordance with an embodiment of the present teaching;

FIG. 4A shows an example ad with multiple attributes, each of which has a set of assets, and asset combinations to assemble the ad, in accordance with an embodiment of the present teaching;

FIG. 4B illustrates ad asset combinations and their associated predicted performance metrics with respect to multiple segments, in accordance with an embodiment of the present teaching;

FIG. 4C illustrates exemplary types of segments;

FIG. 4D shows an exemplary approach to evaluate cross-segment performance, in accordance with an exemplary embodiment of the present teaching;

FIG. 4E shows exemplary estimated performance metrics associated with combinations of different assets generated via generative AI, in accordance with an exemplary embodiment of the present teaching;

FIG. 5A depicts an exemplary high-level system diagram of an AI-assisted ad asset generator, in accordance with an embodiment of the present teaching;

FIG. 5B illustrates exemplary types of objectives that can be used in estimating performance metrics of combinations of ad assets, in accordance with an embodiment of the present teaching;

FIG. 5C illustrates exemplary types of asset creation variables for controlling an asset creation process, in accordance with an embodiment of the present teaching;

FIG. 5D illustrates exemplary types of modifying variables that may be used to control an asset creation process, in accordance with an exemplary embodiment of the present teaching;

FIG. 6A is a flowchart of an exemplary process for obtaining generative AI models for an AI-assisted ad asset generation, in accordance with an embodiment of the present teaching;

FIG. 6B is a flowchart of an exemplary process for an AI-assisted ad asset generator to generate attribute assets of an ad based on base ad information, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

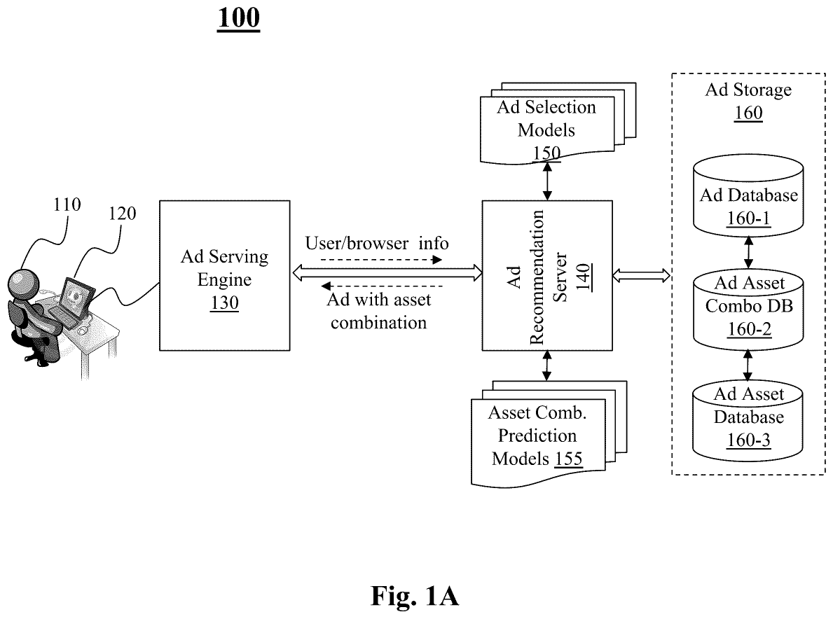

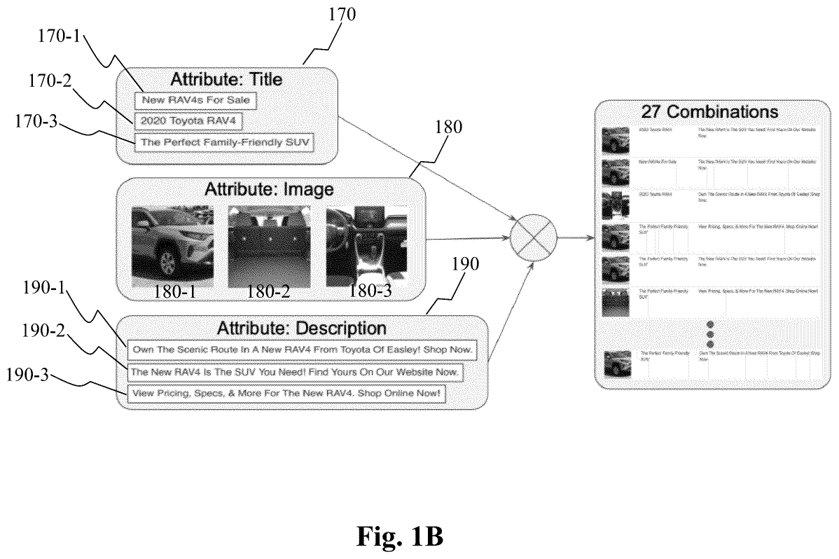

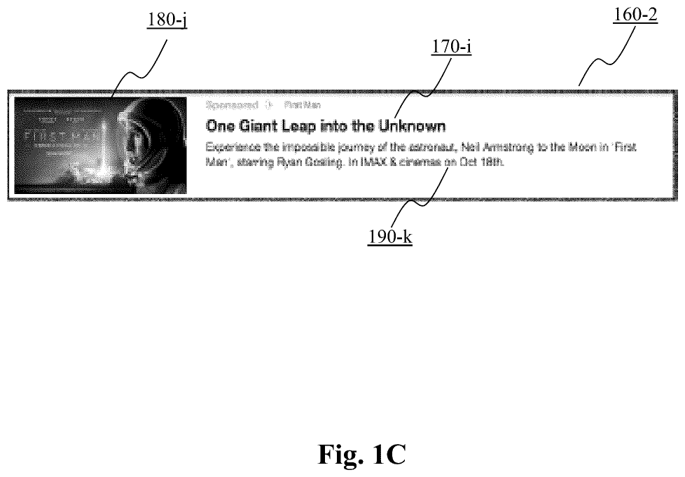

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or systems have been described at a relatively high-level, without detail, in order to avoid unnecessarily obscuring aspects of the present teachings.

The present teaching discloses automatically creating ad assets of different attributes based on generative AI. Traditionally each ad may be assembled and displayed with a particular combination of ad attribute assets for each dynamic-creative optimization (DCO), advertisers need to provide multiple assets for each ad attribute in a predetermined manner regardless of preferences of different locales or individuals. For example, if three assets are provided for each of the three attributes of an advertisement, there can be 3×3×3=27 combinations that the system can choose from for rendering the DCO ad. It is fixed for any segment and any individual. It may often be the case that different segments may prefer different exhibitions of the same DCO ad. For example, e.g., audiences in Florida may prefer a sports car DCO ad to be presented in bright colors and audiences in New York may prefer the same DCO ad to be presented in a darker theme such as black color. Users in a younger age group may prefer the ad with a red car, while a metallic sports car may be more attractive to users in a professional group. Given that, assets to be used for assembling and rendering the sports car DCO ads may differ across different user segments. Such differences in preferences may be identified based on, e.g., past performances of the ad against different segments and may be used as metrics by generative AI as disclosed herein to create assets appropriate to different underlying segments.

According to the present teaching, an AI-assisted ad asset generator may be provided that generates ad assets based on base ad information (e.g., a sports car ad with a base set of assets) in accordance with a generative AI model. The generative AI model may be obtained via machine learning based on feedback information with respect to different display ads previously presented to users of different segments. Such a derived generative AI model may then be applied to each ad to be displayed to create ad assets for different segments with, e.g., respective estimated performance metrics. Such created ad assets with estimated performance metrics may then be used to facilitate, during an ad recommendation process, the selection of a particular asset combination for each DCO ad based on contextual information associated with an ad display opportunity.

In some embodiments, the performance metric may be estimated with respect to some criteria defined in accordance with, e.g., a click-through rate CTR or conversion rate CVR. Different asset combinations of an DCO ad with respect to each segment may form a combination distribution. Such estimated performance metrics for each ad may form a matrix with rows corresponding to combinations and columns corresponding to segments. For example, given the contextual information associated with an ad display opportunity, a particular segment to which an underlying user belongs may be determined. A combination distribution of an DCO ad with respect to the determined segment (a column) may then be assessed based on respective predicted performances with respect to different asset combinations (rows). Such a combination distribution may be generated based on some explore/exploit approach/algorithm. For instance, with respect to each DCO and segment, a uniform distribution may first be initialized over all combinations. Over time, certain metrics (e.g., CTR or CVR) may be measured against respective combinations and such performance-based metrics may then be used to modify the corresponding distributions. For instance, a successive elimination algorithm may be used to eliminate combinations based on confidence and divide the probability mass among the survivors until the best combination is selected. Another example is to use an auxiliary model, such as a CTR/CVR prediction model which includes the assets as features, to determine the combination distribution using the prediction model. In selecting a best combination, a particular combination (one row) that yields the best predicted performance may be selected as the optimal asset combination to be used to assemble and render the DCO ad to the user.

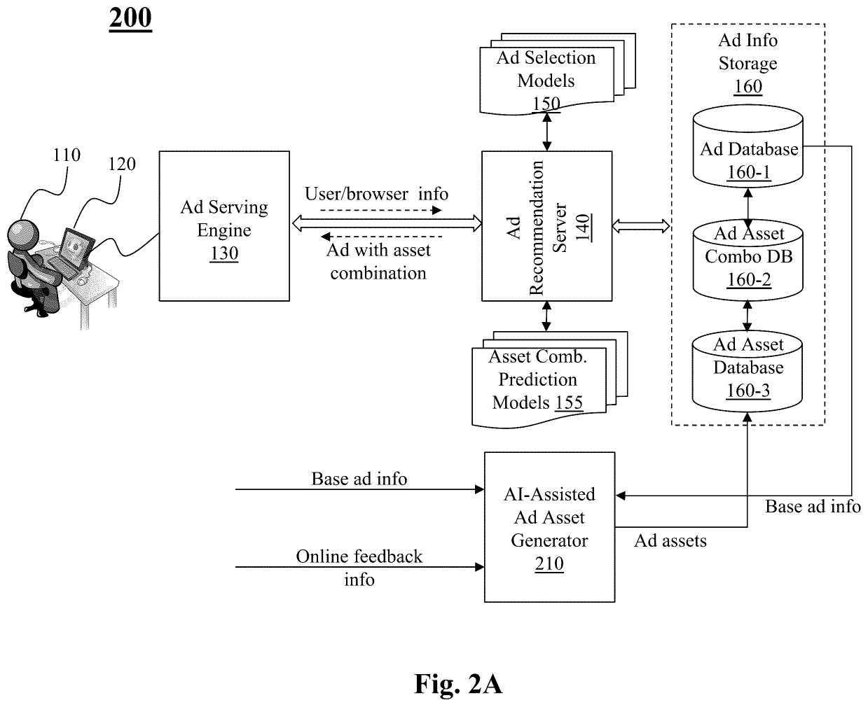

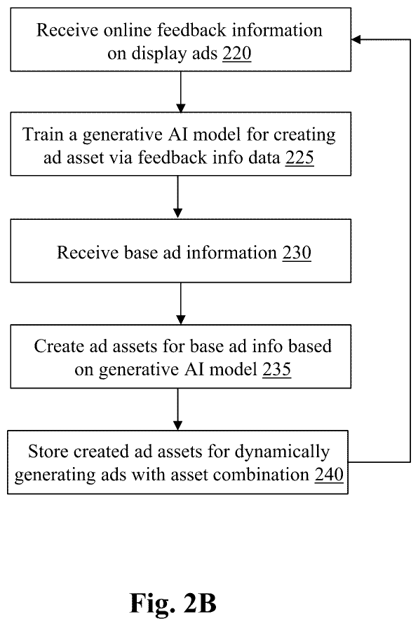

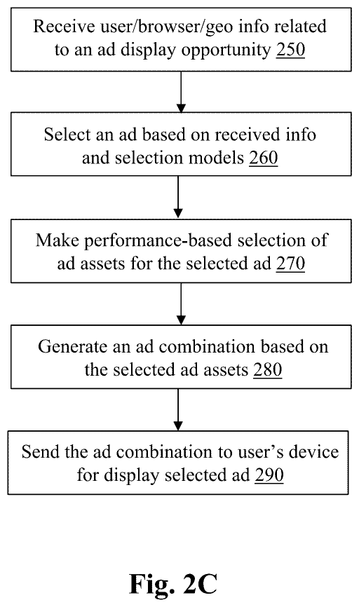

FIG. 2A depicts an exemplary high level system diagram of an ad recommendation framework 200 that operates based on ad assets automatically generated via generative AI, in accordance with an embodiment of the present teaching. In this illustrated embodiment, the ad recommendation framework 200 comprises an ad recommendation portion and an ad asset generation portion, which dynamically and adaptively generates ad assets via generative AI based on some criteria such as some optimization scheme specified to maximize the predicted performance of a DCO ad in a particular asset combination. The ad recommendation portion includes an ad serving engine 130 and an ad recommendation server 140. The ad serving engine 130 and the ad recommendation server 140 operate the same way as a conventional ad recommendation system. That is, when an ad display opportunity is available on a webpage displayed on device 120 of a user 110, the ad serving engine 130 sends a request for an ad recommendation to the ad recommendation server 140. With ad selection models 150, trained via machine learning, the ad recommendation server 140 selects a recommended DCO ad from the ad storage 160 in its asset combination and sends it to the ad serving engine 130 for it to proceed with the auction.

The ad recommendation server 140 as described herein is also provided to obtain asset combination prediction models 155 via machine learning based on training data (stored in the asset combinations archive 160) with asset combinations used for displaying ads and other relevant information such as click or conversion activities from users or lack thereof. Such obtained asset prediction models 155 may be used by the ad recommendation server 140 to generate predicted performances for different asset combinations. When the training data is continually collected, the asset prediction models 155 may be updated over time via retraining based on dynamics of the subsequent user activities on display DCO ads continually collected. Similarly, such continually collected dynamic data may also be used as training data for updating the ad selection models 150.

As discussed herein, the ad recommendation framework 200 also includes an ad asset generation portion, which comprises an AI-assisted ad asset generator 210 for automatically generating ad assets for different segments via generative AI, with predicted performance metrics which may be estimated based on historic performance information. In some embodiments, the AI-assisted ad asset generator 210 may receive base ad information as input, generate ad assets as output, and store such generated ad assets in ad asset database 160-3. That is, the ad assets may be generated with respect to each ad according to the base ad information associated with the ad. For example, for each ad (either in the ad storage 160 and provided externally), its base ad information may be provided, which may include, e.g., a case title, a base image, and a base description, to the AI-assisted ad asset generator 210.

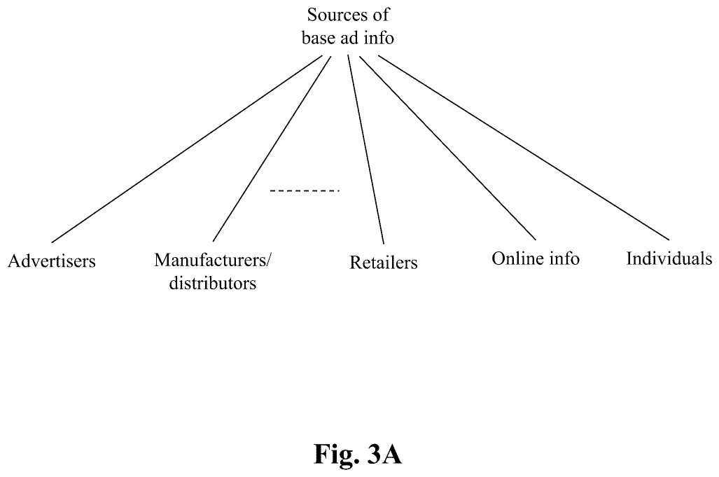

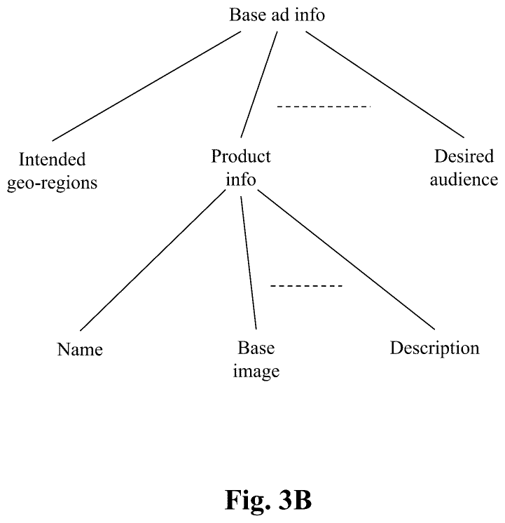

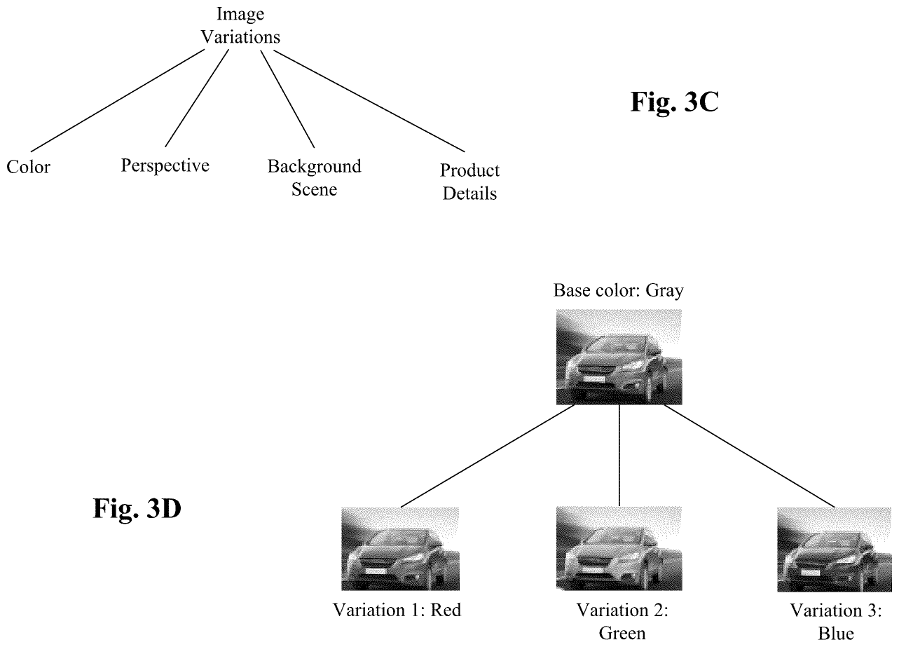

Base ad information may be from different sources. Traditionally, ad information is provided by advertisers. The present teaching may also obtain information from other sources in order to generate ad assets automatically based on a wide range of information sources. FIG. 3A shows exemplary types of sources from where the AI-assisted ad asset generator 210 may obtain base ad information, according to an embodiment of the present teaching. Advertisers may serve as the traditional source of base ad information. In addition to that, the AI-assisted ad asset generator 210 may also retrieve base ad information from, e.g., manufacturers of products to be advertised, or distributors for the same products. For instance, a manufacturer may pose information about their products on their websites and such information may be crawled via public means and used as base ad information to generate ad assets that may be used to create asset combinations for advertising the products. Similarly, product information may also be retrieved from retailers such as Amazon, eBay, etc., other online sources such as websites for reviewing products, or even individuals who may be discussing products with others in some social media setting such as Facebook.

Base ad information may include different types of information. FIG. 3B shows exemplary types of information included in the base ad information, in accordance with an embodiment of the present teaching. It is commonly known that an advertiser may provide, together with information about an ad on a product, intended geo-regions where the ad is to be presented to users, . . . , and desired audience (e.g., young professional as the target demographics). Base ad information also includes information about the product to be advertised such as a name for the product, an image of the product, . . . , and a description of the product. Such information may be utilized by the AI-assisted ad asset generator 210 as the base information in generating more ad assets on the product by, e.g., creating variations from the base information. In some embodiments, the AI-assisted ad asset generator 210 may be configured to create variations within some specified scope and dimension, determined based on, e.g., application needs.

FIG. 3C illustrates an exemplary configuration specifying the types of variations or modifications that may be applied to an image of a product in the base ad information in generating additional ad assets, in accordance with an exemplary embodiment of the present teaching. In this example, the variations that may be applied to a base ad image include changes to the color, the perspective, the background scene, . . . , and some details of the product to be advertised. FIG. 3D illustrates exemplary ad assets automatically generated by the AI-assisted ad asset generator 210 by modifying colors of the product (a car) via generative AI to base ad information of a product, in accordance with an embodiment of the present teaching. In this example, a base ad image depicts that the advertised car is gray. To generate ad assets based on this base image, the car may be detected so that different colors may then be applied to the body of the car, as seen in FIG. 3D with variation 1 in red, variation 2 in green, and variation 3 in blue. Via generative AI, the perspectives of the car may also be modified (not shown). In this manner, given a base product image, various ad assets may be generated automatically so that all these ad images with different colors of the car may be used to create different advertisements.

As discussed herein, the AI-assisted ad asset generator 210 may generate different assets by creating varying ad information in accordance with the base ad information. For example, the automatically generated assets may include images of the same product with visual features that differ from the given base image of the ad. As another example, the automatically generated assets may also include varying titles for the ad with, e.g., altered textual message, e.g., in a different language or with localized name for the product or with some different fonts or text sizes. As discussed herein, the generation of additional ad assets may be with respect to different segments and according to the feedback information collected. In some embodiments, the online feedback information may include user activities on previously displayed ads in different ad asset combinations. Such feedback information may be collected and analyzed with respect to different segments so that adaptation may be achieved with respect to individual segments. For instance, from collected feedback information, it may be uncovered that people in Florida (a segment) react more favorably to ad asset combinations with products presented in bright and more striking colors, while audiences in Maine (a different segment) generally react better to ad combinations with products presented in more subdued colors. People of a young age group (a segment) may react more positively (e.g., more likely to click on the ads) to ads that presented some detailed interior electronic features of a car while people in a retired age group (another segment) often react more positively to ads that presented interior fixture design to show, e.g., materials and/or sizes of car seats on comfort. Based on such online feedback information, the AI-assisted ad asset generator 210 may adapt the generation of ad assets with respect to different segments.

FIG. 2B is a flowchart of an exemplary process for the AI-assisted ad asset generator 210 based on a generative AI model, in accordance with an embodiment of the present teaching. Online feedback information is first received at 220 with respect to different display ads. Based on the received feedback information, a generative AI model for creating ad assets is trained via machine learning from the feedback information at 225. In some embodiments, the trained generative AI model may learn segment-dependent characteristics which may be dynamically adjusted over time based on continually collected feedback information. With the trained generative AI model, when base ad information is received at 230, the AI-assisted ad asset generator 210 creates, at 235, ad assets related to the base ad information using the generative AI model. Such created ad assets are then stored, at 240, in 160-3 and may be subsequently used for creating different ad asset combinations. When the generative AI model may be trained based on segment-sensitive training data, it may be used to automatically control to generate segment-sensitive ad assets with respect to different segments.

FIG. 2C is a flowchart of an exemplary process for recommendation of an ad in a particular asset combination using ad assets generated via generative AI and selected based on estimated performance metrics, in accordance with an embodiment of the present teaching. When the ad recommendation framework 200 receives, at 250, a request for an ad with respect to an ad display opportunity, contextual information such as user, browser, geo-locale, etc. may be received as well. Based on such information, the ad recommendation server 140 selects, at 260, an ad based on the ad selection model and the received contextual information. For the selected ad, ad assets may then be selected, at 270, based on estimated performance metrics and the selected ad assets may then be used to generate, at 280, an ad combination for rendering the selected ad. The recommendation of the ad and the specific performance-based ad asset combination may then be sent to the ad serving engine 130 for displaying the selected ad according to the ad asset combination.

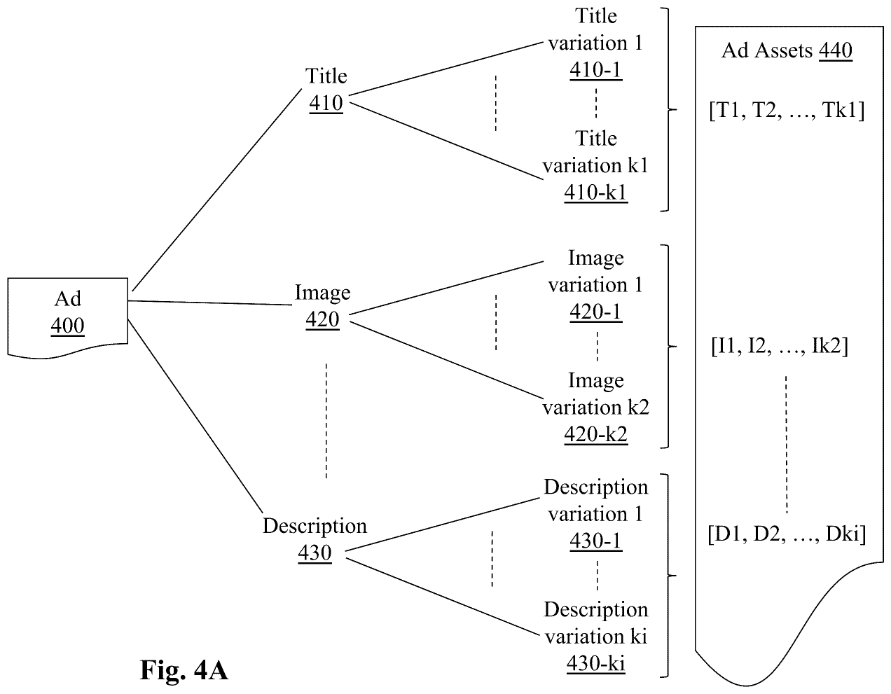

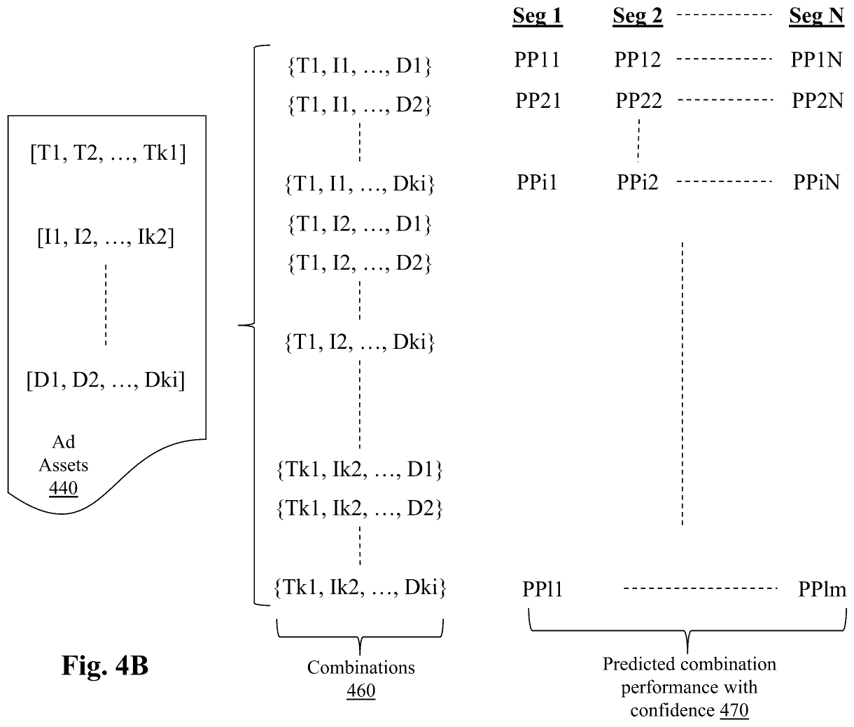

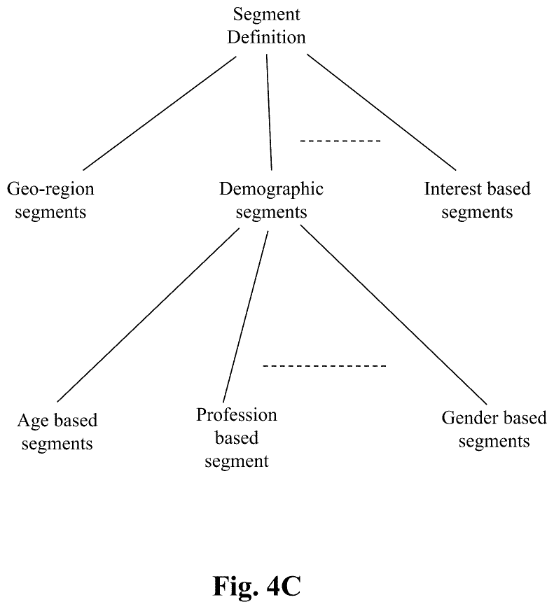

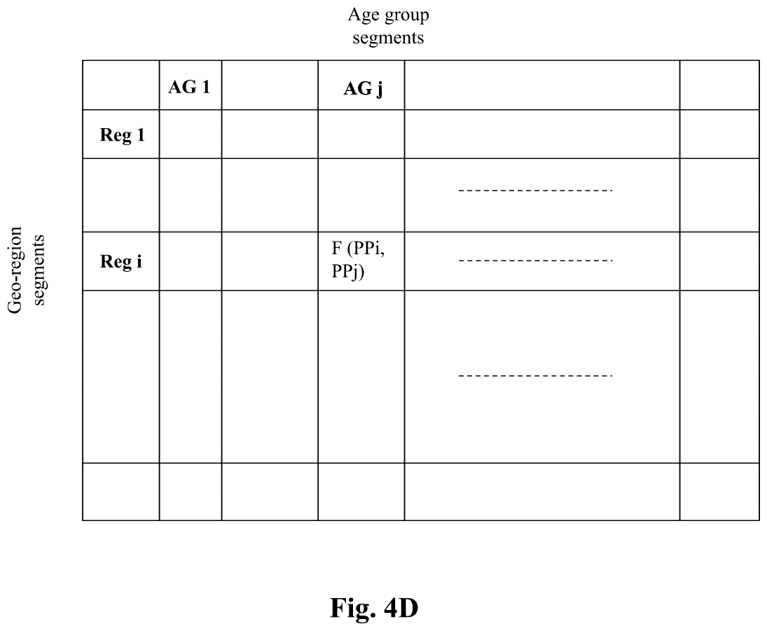

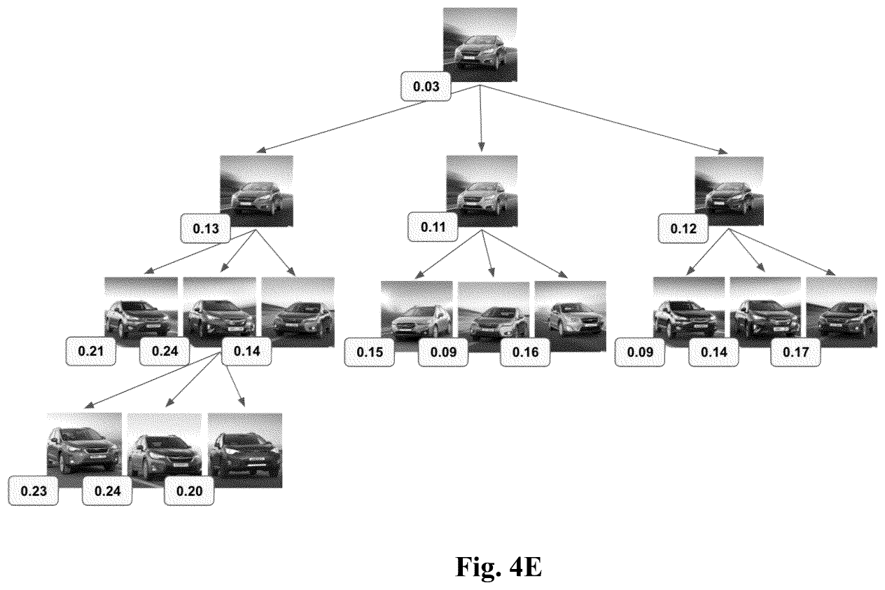

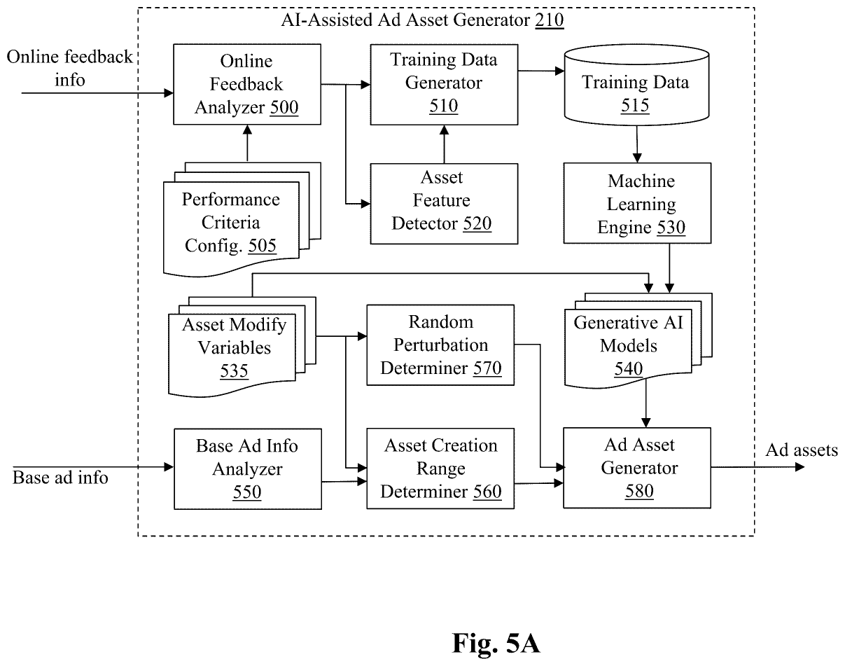

As discussed herein, based on the automatically generated ad assets, the ad recommendation server 140 may generate, for each of the ad asset combination, an estimated performance metric, wherein the ad asset combinations in 160-2 may utilize the ad assets created via generative AI by the AI-assisted ad asset generator 210 and stored in ad asset database 160-3. FIG. 4A shows an example ad 400 with multiple attributes 410, 420, . . . , 430, each of which has a set of assets 410-1, . . . 410-k1 for attribute 410 (e.g., base title of a product), 420-1, . . . , 420-k2 for attribute 420 (base image for the product), . . . , and 430-1, . . . , 430-k1 for attribute 430 (e.g., base description for the product). The ad assets 410-1, . . . , 410-k1, 420-1, 420-k2, . . . , 430-1, . . . , 430-k1 correspond to ad asset sets 440 [T1, T2, . . . , Tk1](titles) [I1, I2, . . . , Ik2](images) and [D1, D2, . . . , Dki](descriptions) and at least some of them are created by the AI-assisted ad asset generator 210 via generative AI and may be used to generate ad asset combinations for display.

FIG. 4B illustrates ad asset combinations created based on ad asset sets 440 and their corresponding predicted performance metrics computed with respect to multiple segments, in accordance with an embodiment of the present teaching. As illustrated, from ad asset sets 440, different ad combinations 460 may be generated: {T1, I1, . . . , D1}, {T1, I1, . . . , D2}, {T1, I1, . . . , Dki}, {T1, I2, . . . , D1}, . . . {Tk1, Ik2, . . . , Dki}. For each of these ad asset combinations for display ad 400 using a different combination of ad assets, performance metric may be estimated based on, e.g., past performance exhibited with respect to each of segments Seg. 1, Seg. 2, . . . , Seg. N. As illustrated, the performance metrics associated with the first ad asset combination {T1, I1, . . . , D1} with respect to N segments may correspond to PP11, PP12, . . . , PP1N, respectively. Similarly, the performance metrics associated with the second ad asset combination {T1, I1, . . . , D2} with respect to N segments may correspond to PP21, PP22, . . . , PP2N, respectively; . . . , the performance metrics associated with the last ad asset combination {Tk1, Ik2, . . . , Dki} with respect to N segments may correspond to PPL1, PPL2, . . . , PPLm, respectively. Such estimated performance metrics 470 for an ad 400 form a matrix and provide a basis for selecting an ad asset combination with respect to each of the segments.

FIG. 4C illustrates exemplary types of segments that may be considered. As shown, a segment may be a geo-region, a sub-population having some defined demographic characteristics, . . . or a sub-population defined by some shared interest(s). With respect to demographic characteristics, further refined segments may also be possible. For instance, there may be age-based segments (e.g., 5-10, 10-15, 15-25, 25-40, 40-55, 55-65, etc. age groups), profession-based segments (e.g., software engineers, biochemists, chief executive officers, financers, etc.), or gender-based segments. Performance related metrics for each of the ad asset combinations with respect to different segments may be determined based on feedback information collected from previously displayed ads. In some embodiments, parallel processes may be used to determine predicted performance metrics PPij (as shown in FIG. 4B) of different combinations with respect to different traffic segments such as age, gender, geo-region, etc. In some situations, the contextual information associated with an ad display opportunity may exhibit cross-segment situations. For example, a user to whom an ad is to be displayed may be in the age group of 25-40 and located in a specific geo-region. In this situation, the segment-specific performance metrics with respect to the relevant segments may be combined in some way to create a compound performance metric.

FIG. 4D shows an exemplary approach to evaluate cross-segment performance, in accordance with an exemplary embodiment of the present teaching. In this example, the performance metrics with respect to the involved segments may be combined using some defined function to derive a single performance metric. For example, for a user in geo-region Reg i having a performance metric PPi and age group AGj having a performance metric PPj, a joint performance metric may be a function of PPi and PPj, as illustrated in FIG. 4D. It is understood that such examples are provided merely for illustration purposes and are not to serve as limitations on the scope of the present teaching. Any other means to combine segment performance metrics to generate a single overall performance metric may be utilized and they are all within the scope of the present teaching.

FIG. 4E shows exemplary estimated performance metrics associated with different ad assets with respect to some segment, in accordance with an exemplary embodiment of the present teaching. As shown, a base ad image in color gray is used to create various ad assets: at the first level of the tree on the top is a car in gray color, at the second level, three ad assets are created via generative AI with colors (red, green, and blue) varied from the base color gray, at the third level, based on each ad asset in a different color, cars in that color but with different perspectives are created, at the fourth level, based on an ad asset with color red and a particular perspective, different backgrounds of the car image are used to create different ad assets. For each of these created ad assets, a performance metric is estimated for each with respect to some segment and such performance metrics are shown at the lower left corner of each ad asset in FIG. 4E.

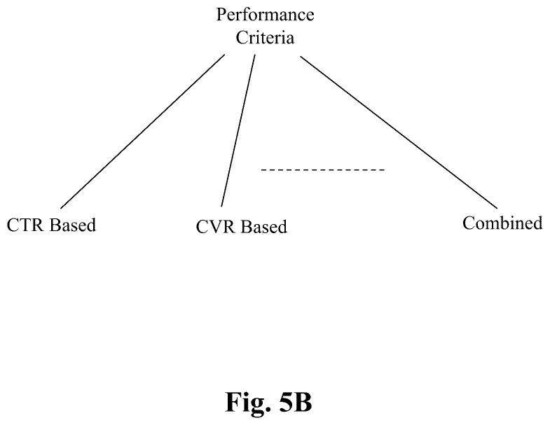

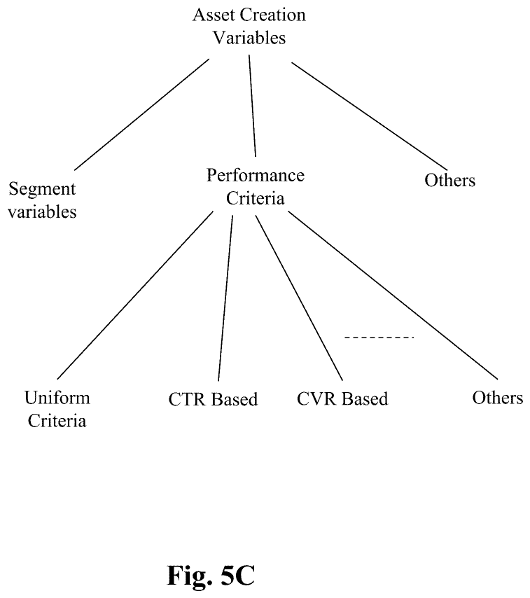

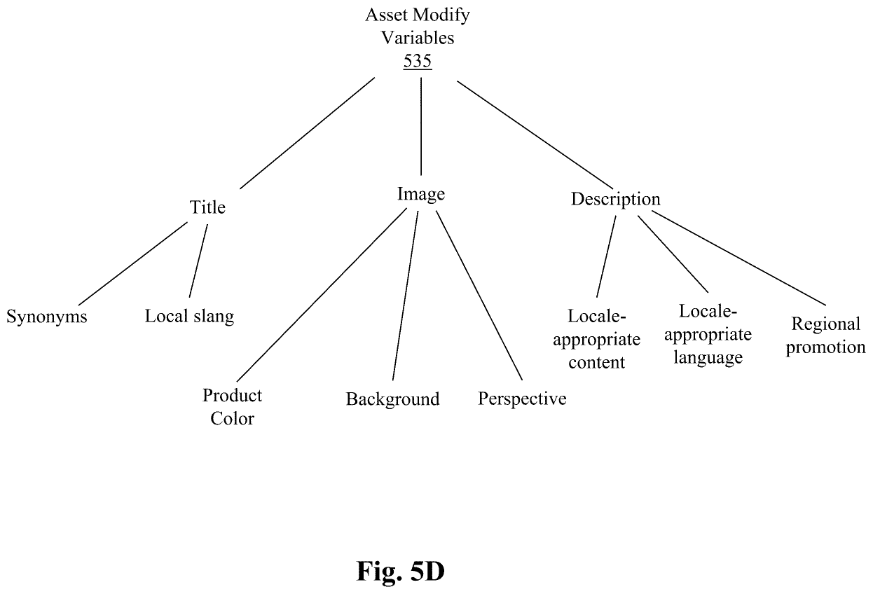

FIG. 5A depicts an exemplary high-level system diagram of the AI-assisted ad asset generator 210, in accordance with an embodiment of the present teaching. As discussed herein, to generate ad assets, generative AI models may be obtained via machine learning based on training data generated from, e.g., online feedback information. With such obtained generative AI models, ad assets may be created according to base ad information associated with each ad or product. Thus, in the illustrated embodiment as shown in FIG. 5A, the AI-assisted ad asset generator 210 includes two parts, one for obtaining generative AI models needed for creating ad assets and the other for producing ad assets based on input base ad information using the generative AI models.

The first part of obtaining generative AI models via machine learning comprises an online feedback analyzer 500, an asset feature detector 520, a training data generator 510, and a machine learning engine 530. Online feedback information may include ads that have previously been displayed to users, contextual information associated with each display (such as demographics of the user and associated segment), geo-location of the user at the time of the display, outcome of the display ad (such as whether there is a click or conversion), and ad assets and features thereof used to render the ad at the time, etc. Such information may be used to analyze relationships between ad assets in different combinations for rendering ads in different contexts and the outcome thereof. In some examples, the online feedback information may be analyzed with respect to different segments so that correlations between ad assets used to display ads and ad performances with respect to each segment may be recognized and leveraged.

The online feedback analyzer 500 may be provided to process and analyze online feedback information to generate groups of feedback information organized based on, e.g., segments. Performance metrics associated with previously displayed ads may be determined according to configured performance criteria in 505. The performance criteria may be configured according to application needs. FIG. 5B illustrates exemplary types of criteria that can be used in estimating performance metrics of combinations of ad assets, in accordance with an embodiment of the present teaching. As seen in FIG. 5B, in some applications, ad performance may be measured according to click rate or CTR so that performance metrics computed in such applications may be CTR based. In some applications, ad performance may be computed based on conversions or CVR. In these applications, the performance metrics may be defined based on conversion activities. In some situations, both CTR and CVR may be relevant so that the performance metrics may be defined based on both types of activities.

Performance metrics yielded by each ad may be determined from the online feedback information with respect to different segments so that such performance metrics may be segment centric. The asset feature detector 520 may be provided to identify features associated with ad assets used for rendering each ad, which may include, e.g., the background and color used in image asset, the language of the title/description used to present textual information, and/or the way the product is presented, e.g., the perspective used, whether included detailed product information, and/or the font style/size of the title/description of the ad, etc. Such identified features may facilitate the learning on which assets with what features may be more effective in driving a preferred return or performance.

The training data generator 510 may be provided to generate training data 515 for machine learning generative AI models 530. In some embodiments, the generated training data may include segment information, ad information (e.g., category of the product being advertised), ad assets and features thereof used to render the ad, user information (e.g., demographics of the user), ad performance metrics, and/or ad display environments such as browser, Operating System (OS) platform, etc., The training data generator 510 may extract such features from the online feedback information or obtain asset features detected by the asset feature detector 520. Such features for each ad may then be used to generate a record as part of the training data 515. In some embodiments, the online feedback information may be processed as batched to generate batch training data. The generated training data is then utilized by the machine learning engine 530 to obtain the generative AI models 540 in the first part of the AI-assisted ad asset generator 210.

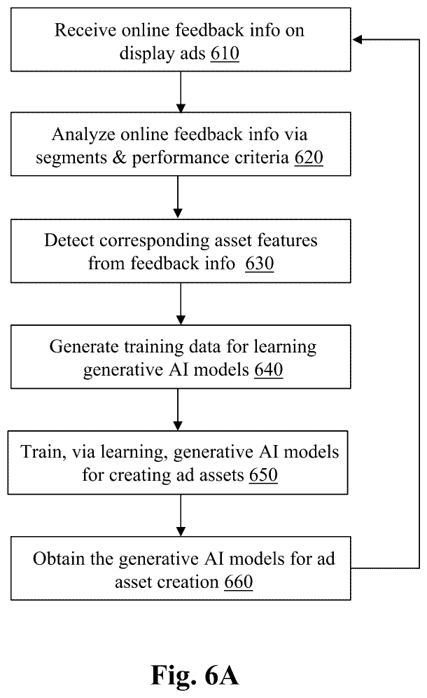

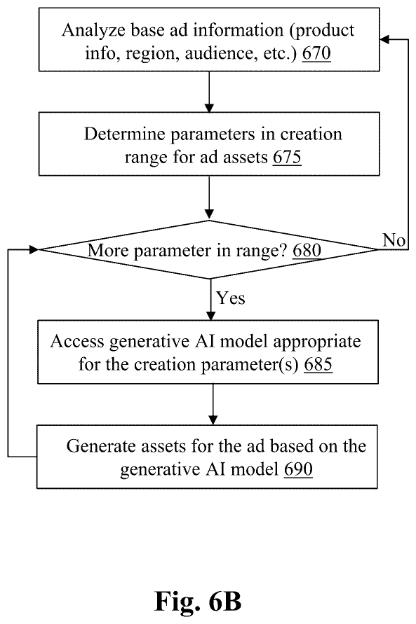

FIG. 6A is a flowchart of an exemplary process for the first part of the AI-assisted ad asset generator 210 for obtaining generative AI models 540 for an AI-assisted ad asset generation, in accordance with an embodiment of the present teaching. When the online feedback information is received at 610, the online feedback analyzer 500 analyzes, at 620, the received feedback information with respect to segments and corresponding performance metrics. The asset feature detector 520 detects, at 630, features associated with the ad assets in the displayed ads and such ad asset features may then be used, together with segmented based performances, to generate, by the training data generator 510 at 640, training data 515 to be used for learning the generative AI models 540. The machine learning engine 530 us then invoked to train, at 650, the generative AI models 540 based on the batch generated training data. The trained generative AI models 540 are then obtained, at 660, for use in creating ad assets.

As discussed herein, the AI-assisted ad asset generator 210 includes two parts and the second part may be provided for generating ad assets based on trained generative AI models 540. In the illustrated embodiment as shown in FIG. 5A, the second part comprises a base ad information analyzer 550, an asset creation range determiner 560, a random perturbation determiner 570, and an ad asset generator 580. As discussed herein, ad assets may be generated based on base ad information, which may include base information on a product, some intended geo-regions, . . . , and/or desired target audiences. The base ad information analyzer 550 may be provided for analyzing the base ad information and extract relevant information that may be used to determine the scope of the ad asset generation. For example, the base ad information analyzer 550 may identify information related to the intended geo-regions as well as desired target audiences for an ad as specified in the base ad information and provide such information to the asset creation range determiner 560 to determine the scope of segment for which ad assets are to be generated.

In some embodiments, the asset creation range determiner 560 may be provided to determine an appropriate scope for ad asset creation for each ad. Such a scope may be determined based on different considerations. FIG. 5C illustrates exemplary types of variables that may affect the scope of asset creation, in accordance with an embodiment of the present teaching. As illustrated, in some embodiments, ad assets for an ad may be created only with respect to some specified segments (e.g., defined based on geo-regions and/or target audience groups), if historically have yielded certain level of expected performance, or other considerations appropriate for an application in hand. With respect to the performance consideration, the expected performance level may be measured in terms of different criteria, including some uniform criteria, some CTR or CVR based criteria, or criteria based on other metrics. In some situations, relevant information extracted from base ad information may be utilized to determine the scope of the creation. For example, if an ad is about an agricultural harvesting equipment, its intended geo-regions may be limited to those engaged in agriculture and its desired target audience may be limited to farmer users. In this example, the scope of ad assets creation may be limited to certain segments, determined in terms of both geography (agricultural regions) and demographics (farmers). In some embodiments, the creation of ad assets may not be limited in this manner. Instead, ad assets may be generated for all segments.

With the scope of creation determined (by the asset creation range determiner 560), the ad asset generator 580 is provided for generating ad assets based on the base ad information with different modifications. As illustrated in FIGS. 3D and 4E, given a base image of a car with a given color (gray) in a certain perspective and a background, different image assets of the same product may be created with different colors, perspectives, and backgrounds by the ad asset generator 580 via generative AI models 540. The trained generative AI 540 may control the creation with respect to different segments based on learned past performance of the assets with respect to these segments. As discussed herein, ad assets created by the generative AI models 540 may be based on base information provided. For instance, a base image of a car in gray with a background may be provided and additional ad assets may be created by modifying certain features exhibited in the base image as shown in FIG. 4E.

In some embodiments, in creating ad assets, the AI-assisted ad asset generator 210 may provide a mechanism to specify, in the asset modify variables 535 in FIG. 5A, the allowed variations from the base ad information. FIG. 5D illustrates exemplary types of modifying variables that may be specified to control an asset creation process, in accordance with an exemplary embodiment of the present teaching. In this example, the asset modifying variables 535 may be specified in the following manner. On the title of a product involved in the ad, synonyms or local slang may be used to replace words in the title. Based on the base image of the product, the allowed modifications include the color, the background, and the perspective of the product. On the base description of the product, the allowed modifications may include adoption of locale-appropriate content and/or local-appropriate language as well as addition of regional promotions. Based on the allowed modification variables, the random perturbation determiner 570 may be provided to generate modifications in different features to be used to create ad assets. For instance, if color modification is allowed, the random perturbation determiner 570 may determine different color modifications to be used and such determined modifications may be provided to the ad asset generator 580 so that the modified features may be used to control the ad asset creation process.

In some applications, additional ad assets may be created beyond modification of base features. For instance, for a car as the advertised product, the base image may represent the exterior of the car. Although some ad assets may be created by modifying the visual features in the base image (e.g., color of the car and background of the scene), additional images associated with the same product may also be supplemented as ad assets to generate asset combinations. For example, images showing the same product in different perspectives may be used to create additional ad assets. Images of the same product taken from different geo-regions with a different climate (e.g., snowy scene) may also be used to create ad assets. Such additional information may be searched on-the-fly from online sources, e.g., manufacturer's websites, dealerships' websites, online magazines, etc.

Similarly, in addition to modifying the base text in a title and a description of an ad, appropriate additional text may also be obtained and used to create additional ad assets. For example, a translation of the original title in English may be obtained for ad assets created for a segment corresponding to a non-English speaking region and such a translation may be obtained on-the-fly when needed. As another example, when there is a manufacturer issued regional promotion for a product (e.g., snow tires for cars in winter in a northern state), the content of such a promotion may be accessed on-the-fly and added to the end of the product description when generating ad asset for the segment corresponding to the geo-region. In this manner, ad assets may be created as disclosed herein to not only adapt to segment performance but also to the marketplace dynamics in the segment.

FIG. 6B is a flowchart of an exemplary process for the second part of the AI-assisted ad asset generator 210 to create ad assets of an ad based on base ad information using generative AI models 540, in accordance with an embodiment of the present teaching. In operation, upon receiving base ad information for each ad, the base ad information analyzer 550 analyzes, at 670, the base information relevant to ad asset creation. Based on relevant information associated with the ad, the asset creation range determiner 560 determines, at 675, parameters defining the range of ad asset creation. For instance, such parameters may include the segments for which ad assets are to be created or allowed variations to be introduced to base ad asset features (e.g., color). These parameters may then be used to control the ad asset creation process. When within the scope of creation, determined at 680, the ad asset generator 580 accesses, at 685, the trained generative AI models 540 and generates, at 690, ad assets accordingly. As discussed herein, such generated ad assets are stored in the ad asset database 160-3 so that they may be utilized to generate different ad asset combinations in 160-2.

The ad recommendation framework using ad assets automatically generated via generative AI as disclosed herein combines the benefits of DCO with the capabilities of generative AI. With this framework, the ad creative may be continuously evolved and evaluated, on-the-fly, based on online feedback information. It provides the potential to revolutionize the way that businesses create and optimize ad creatives, which is often labor intensive and error prone, and thus, slow. Automating the process of creative production and evaluation makes it more data-driven, performance sensitive, self-adaptive, and at the same time free up human marketers. Although the present teaching may be used to optimize the performance, it may also be used as an alternative that allows exploration of usage of different ad assets, including previously known ineffective ones, in different situations to overcome issues such as ad fatigue. With the framework according to the present teaching, it is also possible to create ad content without traditional human supplied ad information. Automatic search of online information, including multimedia information from different sources, may facilitate generation of ads in different presentations, making the advertising process efficient and diverse.

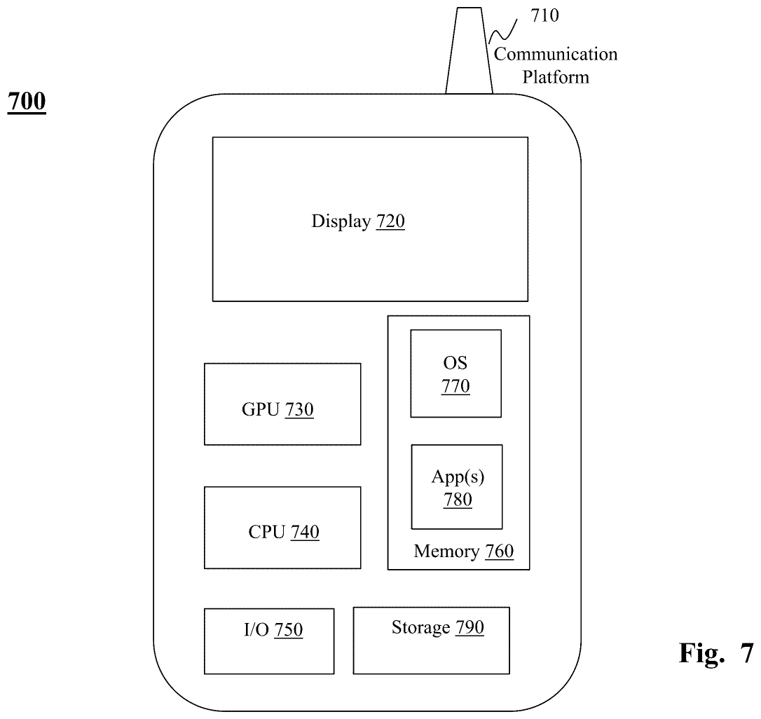

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handheld gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

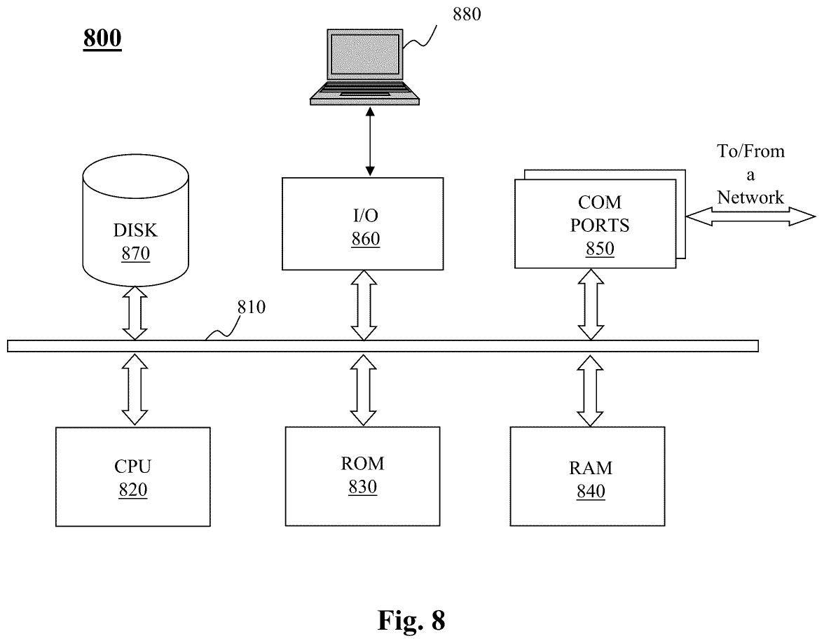

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method, comprising:
obtaining, via machine learning, generative artificial intelligence (AI) models for creating advertisement assets based on training data generated based on online feedback information on previously displayed advertisements;
receiving base advertisement information associated with an advertisement for a product, wherein the base advertisement information specifies a base image to characterize features of the product; and
modifying at least one of the features exhibited in the base image to create different image assets of the product based on the generative AI models, wherein
the different image assets of the product used to form different asset combinations each of which can be used to display the advertisement for the product via an online platform.

2. The method of claim 1, further comprising:
receiving a request for a recommendation of an advertisement for a display advertisement opportunity associated with a user;
accessing information related to a plurality of advertisements and different asset combinations associated each of the plurality of advertisements;
selecting one of the plurality of advertisements based on the request;
selecting one of the different asset combinations associated with the selected advertisement according to performance metrics estimated for the different asset combinations;
generating an advertisement recommendation based on the selected asset combination; and
sending the advertisement recommendation in response to the request.

3. The method of claim 1, wherein the online feedback information includes user activities with respect to the previously displayed advertisements, wherein the user activities include at least one of:
clicks on the previously displayed advertisements; or
conversions related to the previously displayed advertisements.

4. The method of claim 1, wherein
the base advertisement information further specifies at least one of a base title and a base description of the product;
the method further comprising modifying at least one of a base title and a base description of the product to create
different title assets for the product, and/or
different description assets for the product.

5. The method of claim 4, wherein
the different title assets are created based on the base title;
and
the different description assets are created based on the base description.

6. The method of claim 1, wherein the obtaining the generative AI models comprises:
analyzing the online feedback information to identify user activities with respect to the previously displayed advertisements;
determining performance metrics of the previously displayed advertisements based on the identified user activities;
detecting features of advertisement assets used in the previously displayed advertisements;
generating the training data based on the features of advertisements and performance metrics of the previously displayed advertisements; and
training the generative AI models using the training data.

7. The method of claim 1, wherein the creating the plurality of advertisement assets comprises:
determining an asset creation range based on the base advertisement information; and
generating the plurality of advertisement assets within the asset creation range, wherein
the base advertisement information specifies geo-regions and/or a target audience intended for the advertisement, and
the asset creation range specifies one or more segments for which the advertisement assets are to be generated which are determined based on at least one of the geo-regions, the target audience, and some modifying variables defining allowable modifications to be applied to the base advertisement information to create advertisement assets.

8. A non-transitory machine-readable medium having information recorded thereon, wherein the information, when read by a machine, causes the machine to perform the following steps:
obtaining, via machine learning, generative artificial intelligence (AI) models for creating advertisement assets based on training data generated based on online feedback information on previously displayed advertisements;
receiving base advertisement information associated with an advertisement for a product, wherein the base advertisement information specifies a base to characterize features of the product; and
modifying at least one of the features exhibited in the base image to create different image assets of the product based on the generative AI models, wherein
the different image assets of the product are used to form different asset combinations each of which can be used to display the advertisement for the product via an online platform.

9. The medium of claim 8, wherein the information, when read by the machine, further causes the machine to perform the following steps:
receiving a request for a recommendation of an advertisement for a display advertisement opportunity associated with a user;
accessing information related to a plurality of advertisements and different asset combinations associated each of the plurality of advertisements;
selecting one of the plurality of advertisements based on the request;
selecting one of the different asset combinations associated with the selected advertisement according to performance metrics estimated for the different asset combinations;
generating an advertisement recommendation based on the selected asset combination; and
sending the advertisement recommendation in response to the request.

10. The medium of claim 8, wherein the online feedback information includes user activities with respect to the previously displayed advertisements, wherein the user activities include at least one of:
clicks on the previously displayed advertisements; or
conversions related to the previously displayed advertisements.

11. The medium of claim 8, wherein
the base advertisement information further specifies at least one of a base title and a base description of the product;
the method further comprising modifying at least one of a base title and a base description of the product to create
different title assets for the product, and/or
different description assets for the product.

12. The medium of claim 11, wherein
the different title assets are created based on the base title;
and
the different description assets are created based on the base description.

13. The medium of claim 8, wherein the obtaining the generative AI models comprises:
analyzing the online feedback information to identify user activities with respect to the previously displayed advertisements;
determining performance metrics of the previously displayed advertisements based on the identified user activities;
detecting features of advertisement assets used in the previously displayed advertisements;
generating the training data based on the features of advertisements and performance metrics of the previously displayed advertisements; and
training the generative AI models using the training data.

14. The medium of claim 8, wherein the creating the plurality of advertisement assets comprises:
determining an asset creation range based on the base advertisement information; and
generating the plurality of advertisement assets within the asset creation range, wherein
the base advertisement information specifies geo-regions and/or a target audience intended for the advertisement, and
the asset creation range specifies one or more segments for which the advertisement assets are to be generated which are determined based on at least one of the geo-regions, the target audience, and some modifying variables defining allowable modifications to be applied to the base advertisement information to create advertisement assets.

15. A system, comprising:
a processor;
a machine learning engine implemented by the processor and configured for obtaining, via machine learning, generative artificial intelligence (AI) models for creating advertisement assets based on training data generated based on online feedback information on previously displayed advertisements; and
an AI-assisted ad asset generator implemented by the processor and configured for
receiving base advertisement information associated with an advertisement for a product, wherein the base advertisement information specifies a base image to characterize features of the product, and
modifying at least one of the features exhibited in the base image to create different image assets of the product based on the generative AI models, wherein
the different image assets of the product are used to form different asset combinations each of which can be used to display the advertisement for the product via an online platform.

16. The system of claim 15, further comprising an ad recommendation server implemented by the processor and configured for:
receiving a request for a recommendation of an advertisement for a display advertisement opportunity associated with a user;
accessing information related to a plurality of advertisements and different asset combinations associated each of the plurality of advertisements;
selecting one of the plurality of advertisements based on the request;
selecting one of the different asset combinations associated with the selected advertisement according to performance metrics estimated for the different asset combinations;
generating an advertisement recommendation based on the selected asset combination; and
sending the advertisement recommendation in response to the request.

17. The system of claim 15, wherein the online feedback information includes user activities with respect to the previously displayed advertisements, wherein the user activities include at least one of:
clicks on the previously displayed advertisements; or
conversions related to the previously displayed advertisements.

18. The system of claim 15, wherein
the base advertisement information further specifies at least one of a base title and a base description of the product;
the method further comprising modifying at least one of a base title and a base description of the product to create
different title assets for the product created based on the base title, and/or
different description assets for the product created based on the base description.

19. The system of claim 15, wherein the obtaining the generative AI models comprises:
analyzing the online feedback information to identify user activities with respect to the previously displayed advertisements;
determining performance metrics of the previously displayed advertisements based on the identified user activities;
detecting features of advertisement assets used in the previously displayed advertisements;
generating the training data based on the features of advertisements and performance metrics of the previously displayed advertisements; and
training the generative AI models using the training data.

20. The system of claim 15, wherein the creating the plurality of advertisement assets comprises:
determining an asset creation range based on the base advertisement information; and
generating the plurality of advertisement assets within the asset creation range, wherein the base advertisement information specifies geo-regions and/or a target audience intended for the advertisement, and
the asset creation range specifies one or more segments for which the advertisement assets are to be generated which are determined based on at least one of the geo-regions, the target audience, and some modifying variables defining allowable modifications to be applied to the base advertisement information to create advertisement assets.
